(19) United States
(12) Patent Application Publication
(10) Pub. No.: US 2010/0037620 A1
(43) Pub. Date: Feb. 18, 2010

(54) Impingement and effusion cooled combustor component

(75) Inventor: Ronald J. Chila, Greer, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, New York, NY (US)

(21) Appl. No.: 12/222,781

(22) Filed: Aug. 15, 2008

(51) Int. Cl. F02C 7/12

(52) U.S. Cl. 60/752; 415/116

(57) ABSTRACT

A cooling arrangement for cooling a first turbine combustor component surrounded by a second component includes a first plurality of impingement cooling holes in the second component, the impingement cooling holes directing cooling air onto designated areas of the first turbine combustor component; and a second plurality of effusion cooling holes in the first turbine combustor component located to cool by effusion other areas of the first turbine combustor component.

This invention relates to turbomachinery and specifically, to the cooling of combustor and transition pieces in gas turbine combustors.

### BACKGROUND OF THE INVENTION

Conventional gas turbine combustion systems employ multiple combustor assemblies to achieve reliable and efficient turbine operation. Each combustor assembly includes a cylindrical liner, a fuel injection system, and a transition piece that guides the flow of the hot gases from the combustor to the inlet of the turbine. Generally, a portion of the compressor discharge air is used to cool the combustor liner and is then introduced into the combustor reaction zone to be mixed with the fuel and burned.

In systems incorporating impingement cooled transition pieces, a hollow flow sleeve surrounds the transition piece, and the flow sleeve wall is perforated so that compressor discharge air will flow through the cooling apertures in the sleeve wall and impinge upon (and thus cool) the transition piece. This cooling air then flows along an annulus between the flow sleeve and the transition piece, and then into another annulus between the combustor liner and a second flow sleeve surrounding the liner. The second flow sleeve is also formed with several rows of cooling holes about its circumference, the first row located adjacent a mounting flange where the second flow sleeve joins to the first flow sleeve.

In combustor configurations utilizing impingement cooling for the combustor liner and/or transition piece (or other combustor component), it is often the case that the pitch between adjacent impingement jets tends to be too large to effectively cool the component. Specifically, the large pitch spacing gives rise to areas which are left uncooled (sometimes referred to as “hot spots), and also to excessive thermal gradients. There remains a need therefore to improve the cooling efficiency of impingement cooled combustor components.

### BRIEF DESCRIPTION OF THE INVENTION

In accordance with exemplary but nonlimiting embodiments, this invention employs effusion cooling in regions where impingement cooling is deficient. Thus, in one aspect, the present invention relates to a cooling arrangement for a first turbine combustor component surrounded by a second turbine combustor component, the cooling arrangement comprising: a first plurality of impingement cooling holes in the second turbine combustor component, the plurality of impingement cooling holes directing cooling air onto designated areas of the first turbine combustor component; and a second plurality of effusion cooling holes in the first turbine combustor component located to cool by effusion other areas of the first turbine combustor component.

In another aspect, the invention relates to a method of cooling a turbine combustor component comprising: (a) surrounding the turbine combustor component with a flow sleeve, with an annular flow passage between the turbine component and the flow sleeve; (b). providing a plurality of impingement cooling holes in the flow sleeve adapted to supply cooling air onto designated areas of the turbine component; and (c) providing a plurality of effusion cooling holes in the turbine combustor component adapted to supply cooling air to other designated areas of the turbine combustor component.

The invention will now be described in detail in connection with the drawings identified below.

### BRIEF DESCRIPTION OF THE DRAWINGS

FIG. 1 is a schematic representation of a known gas turbine combustor; and

FIG. 2 is a partial section in schematic form of a combustor liner and impingement flow sleeve in accordance with an exemplary embodiment of the invention; and

FIG. 3 is a partial perspective view of a flow sleeve and combustor liner in accordance with the invention.

### DETAILED DESCRIPTION OF THE INVENTION

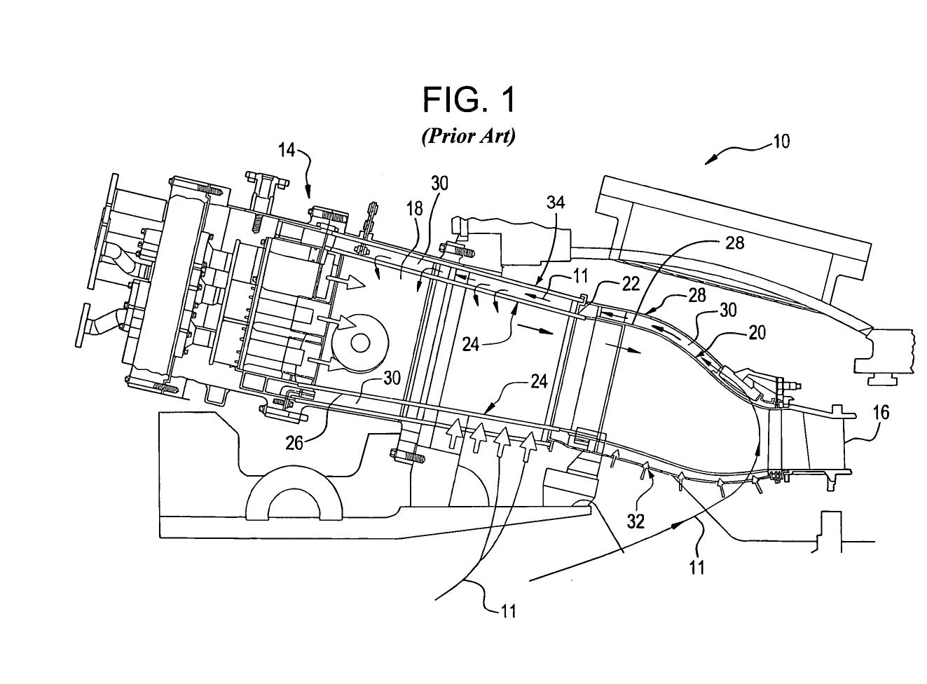

Referring to FIG. 1, a conventional can-annular reverse-flow combustor 10 is illustrated. The combustor 10 generates the gases needed to drive the rotary motion of a turbine by combusting air and fuel within a confined space and discharging the resulting combustion gases through a stationary row of vanes. In operation, discharge air (indicated by flow arrows 11) from a compressor (compressed to a pressure on the order of about 250-400 lb/sq-in) reverses direction as it passes over the outside of the combustors (one shown at 14), and again as it enters the combustor en route to the turbine (first stage nozzle indicated at 16). Compressed air and fuel are burned in the combustion chamber 18, producing gases at temperatures of about 1500° C. or about 2730° F. These combustion gases flow at high velocity into the turbine first stage nozzle 16 via transition piece 20. The transition piece 20 connects to a substantially cylindrical combustor liner 24 at connector 22, but in some applications, a discrete connector segment may be located between the transition piece 20 and the combustor liner. The combustor liner 24 and the transition piece 20 have outside surfaces 26, 28, respectively, over which the cooler compressor discharge air 11 flows.

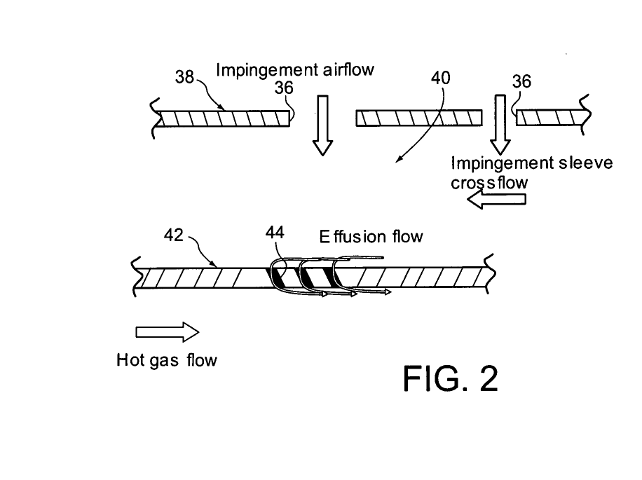

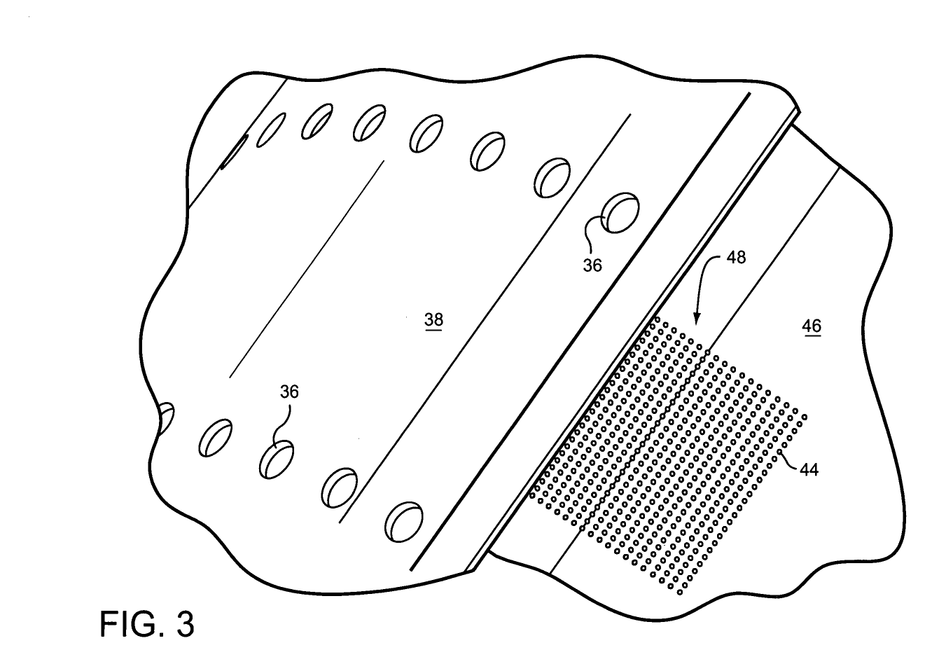

More specifically, in an exemplary but nonlimiting embodiment, the compressor discharge air flows through an annular gap 30 formed by a first flow sleeve 32 surrounding the transition piece 20 and a second flow sleeve 34 surrounding the liner 24. Each flow sleeve 32, 34 has a series of holes, slots, or other openings (not shown, but see similar holes in FIGS. 2 and 3) that allow the compressor discharge air 11 to flow radially through the holes to impinge upon and thus cool the transition piece 20 and liner 24. It will be appreciated that for purposes of this invention, the first and second flow sleeves could be formed as one sleeve, but also, the invention is applicable to either sleeve used alone, without the other.

In the exemplary but nonlimiting embodiment shown in FIGS. 2-3, a plurality of impingement cooling holes 36 are formed in a liner flow sleeve (or second turbine combustor component) 38, permitting compressor discharge air to flow radially into an annulus or flow passage 40 to impinge directly on the liner (or first turbine combustor component) 42. The impingement holes 36 may be arranged in various patterns, for example, in axially spaced annular rows, etc. as best understood from FIG. 3.

Because of the typical large pitch spacing between adjacent impingement hole cooling jets, however, liner cooling is less than optimal. To supplement and enhance the impingement cooling, effusion cooling apertures 44 have been added to the liner 46. More specifically, one or more arrays 48 of effusion cooling apertures 44 are formed in the liner 46 in selected locations where impingement cooling in insufficient.

As shown in FIGS. 2 and 3, for example, an array 48 of effusion cooling apertures 44 is located between adjacent, axially spaced rows of impingement cooling holes 36. The array 48 may be in the form of continuous or discontinuous patterns of apertures about the circumference of the liner 46, and there may be similar or different arrays axially between each adjacent pairs of rows of impingement holes, or in any other space not adequately cooled by jets of air flowing through the impingement holes. The array pattern, i.e., rectangular, square, irregular, etc. may be determined by cooling requirements. In this way, high temperatures (i.e., hot spots) in those areas where impingement cooling is insufficient, can be alleviated while also minimizing thermal gradients. More specifically, as indicated by the flow arrows in FIG. 2, cooling air flowing along and through the annular passage 40, substantially perpendicular to the impingement jets entering the passage 40 via impingement holes 36, will flow through the effusion apertures 44 and establish a film of cooling air along the inside surface of the liner 42, thus enhancing the cooling of the liner, particularly in areas insufficiently cooled by impingement cooling. The effusion holes may be angled to direct the effusion cooling air in the direction of flow of combustion gases in the liner.

In an exemplary but nonlimiting implementation, the impingement holes may have diameters in the range of from about b 0.10 to about 1.0 in. (or if noncircular, substantially equivalent cross-sectional areas). The smaller effusion holes may have diameters in the range of from about 0.02 to about 0.04 in. (or if noncircular, substantially equivalent cross-sectional areas).

The combination of impingement and effusion cooling may be applied to any component where impingement jet pitch spacing yields unfavorable thermal conditions. Such components include but are not limited to combustor liners and transition ducts (or pieces) that supply the hot combustion gases to the first stage nozzle. The number, size, shape and pattern(s) of the impingement cooling holes and the effusion cooling holes are not intended to be limited in any way.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A cooling arrangement for cooling a first turbine combustor component surrounded by a second turbine combustor component, the cooling arrangement comprising:
a first plurality of impingement cooling holes in said second turbine combustor component, said plurality of impingement cooling holes directing cooling air onto designated areas of said first turbine combustor component; and
a second plurality of effusion cooling holes in said first turbine combustor component located to cool by effusion other areas of said first turbine combustor component.

2. The cooling arrangement of claim 1 wherein said first plurality of impingement cooling holes are arranged in ordered arrays in said second turbine combustor component, and said effusion cooling holes are arranged in said first turbine combustor component in an area offset from said first plurality of impingement cooling holes.

3. The cooling arrangement of claim 2 wherein said second plurality of effusion cooling holes are angled to direct effusion cooling air in a direction of flow of combustion gases in said first component.

4. The cooling arrangement of claim 2 wherein said first plurality of impingement cooling holes are round, each defined by a specified cross-sectional area, and wherein said second plurality of effusion cooling holes are round and have cross-sectional areas relatively smaller than said first plurality of impingement holes.

5. The cooling arrangement of claim 4 wherein said first plurality of impingement holes have diameters in a range of from about 0.10 to about 1.0 in. and said second plurality of effusion holes have diameters in a range of from about 0.02 to about 0.04 in.

6. The cooling arrangement of claim 1 wherein said first turbine combustor component comprises a substantially cylindrical combustor liner, and said second turbine combustor component comprises a flow sleeve.

7. The cooling arrangement of claim 1 wherein said first turbine combustor component comprises a transition duct and said second turbine combustor component comprises a flow sleeve.

8. A method of cooling a turbine combustor component comprising:
(a) surrounding said turbine combustor component with a flow sleeve, with an annular flow passage between said turbine combustor component and said flow sleeve;
(b) providing a plurality of impingement cooling holes in said flow sleeve adapted to supply cooling air onto designated areas of said turbine combustor component; and
(c) providing a plurality of effusion cooling holes in said turbine combustor component adapted to supply cooling air to other designated areas of said turbine combustor component.

9. The method of claim 8 comprising arranging said plurality of impingement cooling holes in ordered arrays in said flow sleeve, and arranging said plurality of effusion cooling holes in said turbine combustor component in an area offset from said plurality of impingement cooling holes.

10. The method of claim 9 comprising angling said plurality of effusion cooling holes to direct effusion cooling air in a direction of flow of combustion gases in said turbine combustor component.

11. The method of claim 8 wherein said turbine combustor component comprises a substantially cylindrical combustor liner.

12. The method of claim 8 wherein said plurality of impingement cooling holes have a specified cross-sectional area, and wherein said plurality of effusion cooling holes have cross-sectional areas relatively smaller than said plurality of impingement holes.

13. The method of claim 10 wherein said plurality of impingement cooling holes are round, each defined by a specified cross-sectional area, and wherein said plurality of effusion cooling holes are round and have cross-sectional areas relatively smaller than said plurality of impingement holes.

14. The method of claim 8 wherein said plurality of impingement holes have diameters in a range of from about to about 1.0 in. and said plurality of effusion holes have diameters in a range of from about 0.02 to about 0.04 in.
